(19) United States
(12) Patent Application Publication
(10) Pub. No.: US 2025/0026581 A1
(43) Pub. Date: Jan. 23, 2025

(54) INSERT FOR A TURNING DEVICE, TURNING DEVICE AND METHOD FOR TURNING MEDICINAL AMPOULES

(71) Applicant: Körber Pharma Inspection GmbH, Markt Schwaben (DE)

(72) Inventors: Tobias Schuster, Pastetten (DE); Wolfgang Heimberg, Ebersberg (DE); Michael Müller, Grafing (DE); Martin Eberl, Grafing (DE)

(21) Appl. No.: 18/773,975

(22) Filed: Jul. 16, 2024

(30) Foreign Application Priority Data
Jul. 18, 2023 (DE) 10 2023 118 975.1

(51) Int. Cl. B65G 47/248; G01N 35/04

(52) U.S. Cl. CPC B65G 47/248; G01N 35/04; G01N 2035/0425

(57) ABSTRACT

An insert for a turning device for medical ampoules includes an input section having a plurality of input apertures for receiving one ampoule in each case and provided in a first arrangement structure, a dispensing section having a plurality of output apertures for dispensing one ampoule in each case and provided in a second arrangement structure, and a transition section having a plurality of guides and arranged such that the output apertures are arranged in a second arrangement structure, wherein the input apertures and the outlet apertures are arranged eccentrically relative to each other.

### BACKGROUND OF THE INVENTION

The present invention relates to a use for a turning device for turning medical ampoules, a turning device for turning medical ampoules, and a method for turning medical ampoules.

Medical ampoules such as cylindrical ampoules or cartridges made of glass are a widely used primary packaging material for transporting drugs administered intravenously. These ampoules can be administered using a cylindrical ampoule syringe. This is particularly suitable for drugs that are self-administered by patients. Such a cylindrical ampoule syringe can be loaded with the ampoule so that it is not necessary to remove the drug from the ampoule (e.g., to draw it into a syringe). This can be done, for example, by inserting the ampoule from the back into the cylindrical ampoule syringe or by inserting the ampoule from the side. The ampoules are designed accordingly and have a connection for a needle of the cylindrical ampoule syringe on their top side and a contact surface for a plunger of the cylindrical ampoule syringe on their bottom side.

In general, increased control standards apply to drugs administered intravenously. This means that the drugs contained in the ampoules must undergo a so-called 100% inspection. During the inspection, optical control methods are used to determine whether there are impurities, particles, or other anomalies in the ampoules. Because the ampoules are usually filled from the side where the plunger of the cylindrical ampoule syringe engages with the ampoule, the filled cylindrical ampoules come out of the filling with the plunger contact element facing upwards. To perform a safe and satisfactory inspection of the ampoules, they must be turned. This is partly due to the fact that the syringe contact element of the ampoule obscures part of the ampoule or the drug contained therein, making a visual inspection of the entire contents of the ampoule not possible in every orientation of the ampoule.

Accordingly, it is necessary to turn the ampoules before inspecting them. In the state of the art, the ampoules are turned individually or in rows using a star turner, a transport belt with a deflection, or using robots. This has the disadvantage that the ampoules must be placed in a certain product distance, which limits the handling speed of the ampoules. Moreover, known turning devices are usually very large and accordingly require a lot of space. In addition, the ampoules are transported in such a way that contact between the individual ampoules is avoided, as the glass ampoules are prone to damage in a glass-glass contact.

It is accordingly an object of the present invention to provide a device and a method that enable efficient turning of medical ampoules, taking into account the above conditions.

### SUMMARY OF THE INVENTION

According to one aspect of the present invention, a device for turning medical ampoules is provided. The device may include an input section having a plurality of input apertures for receiving one ampoule each, where the input apertures may be provided in a first arrangement structure. The device may further include an output section having a plurality of output apertures for outputting one ampoule each, where the output apertures may be provided in a second arrangement structure. Additionally, the device may include a transition section having a plurality of guiding means, where the transition section may be arranged and/or designed such that ampoules can be guided from the input apertures through the guiding means to the output apertures. The input apertures and the output apertures can be arranged eccentrically relative to each other.

Compared to the known state of the art, the present invention provides the effect that even arbitrary arrangement structures of medical ampoules can be handled efficiently. An arrangement structure may be a distribution of medical ampoules in a plane (for example, along an X-direction and a Y-direction perpendicular to it). Considering the condition that direct contact of the ampoules (keyword: avoiding glass-glass contact) should be avoided and at the same time as many ampoules as possible should be arranged in a small space, different arrangement structures arise that are not symmetrical when turned. Thus, an array of ampoules provided in a transport container cannot simply be turned as this would result in an arrangement structure that does not fit the transport container or further processing methods. Moreover, it would lead to problems in identifying the ampoules as the position of the ampoules would no longer be traceable. However, the present invention can guide the ampoules from the input apertures to the output apertures in such a way that the ampoules are present in the desired or predefined arrangement structure after being turned. This allows a large number of ampoules to be turned simultaneously, significantly speeding up the process and thereby increasing efficiency.

The medical ampoules can be made of glass and have an internal volume of up to 20 ml. The ampoules can be suitable for being held in nested containers. The ampoules can have a contact section for a syringe (syringe contact element) of an ampoule syringe on one side. At a second opposite end of the ampoule, the ampoule can have a plunger section (plunger contact element) that can interact with a plunger of an ampoule syringe. Ampoules are usually filled with the plunger section facing upwards (in relation to gravity). The ampoules are usually inspected in a turned orientation (i.e., with the syringe contact element facing upwards in relation to gravity). The ampoules can also be syringes without collars (i.e., hanging transport is not possible).

The input section can define a receiving area of the device into which the ampoules can slide into the device. The arrangement structure in which the input apertures are provided can correspond to the holding sections for the provided ampoules. The ampoules can be provided in a holding structure (the so-called nest). Each ampoule can be held in a holding section. In a top view, the holding structure of the ampoules can form a diamond pattern. Each holding section can be designed in the shape of a diamond. This can prevent glass-glass contact between the ampoules, each held in a holding section, while arranging the largest possible number of ampoules in a given area. However, if such an arrangement structure of ampoules is rotated 180° so that the syringe contact element and the plunger contact element swap positions, the individual holding sections, defined by a single diamond of the arrangement structure, are not congruent. Accordingly, the arrangement of the input apertures differs from the arrangement of the output apertures. Thus, ampoules exiting the output apertures can be reinserted into an identically configured holding structure as the one from which the ampoules were taken. In particular, the first arrangement structure can correspond to the arrangement of the ampoules in an unturned orientation, and the second arrangement structure can correspond to the arrangement of the ampoules in a turned orientation. The unturned orientation and the turned orientation can differ by a rotation angle of 180°. The output section can be an area of the device where the ampoules exit the device. The transition section can connect the input section and the output section. The transition section can include guiding means that can be realised, for example, in the form of a channel-like section or in the form of a grid section. The transition section (e.g., the guiding means) can be inclined relative to the input section and/or the output section. This can ensure that the ampoules are transferred from the first arrangement structure to the second arrangement structure. It is important that the guiding means can guide an ampoule from an input aperture to an output aperture. “Guiding” here means that a movement direction of an ampoule is predetermined. The movement direction can be variable in three-dimensional space by the guiding means. In other words, a movement direction in three-dimensional space can be designed so that all three spatial coordinates of a guided ampoule change. Moreover, the input section and/or the output section can be inclined relative to each other. This can simplify the intake of ampoules when the device is rotated around an axis (e.g., the first axis). An early input or sliding of the ampoules into the device can be realised. The same can apply analogously to the output section. An input aperture can be directly connected to a guiding means. Downstream of the guiding means, the output aperture can be directly in contact with the guiding means. In other words, an input aperture, a guiding means, and an output aperture can form a unit designed to transfer an ampoule from the first arrangement structure to the second arrangement structure. The terms input section and output section can depend on the orientation of the device. In other words, the section of the device that is at the top in the direction of gravity can serve as the input section, and the section of the device that is at the bottom in the direction of gravity can serve as the output section. In other words, these designations can change when the device is rotated (i.e., when the orientation of the device is changed). The movement direction of an ampoule through the device remains the same from the input section through the transition section to the output section (upstream starting at the input section through the transition section to downstream to the output section, i.e., in the main movement direction). The output apertures and the input apertures can be arranged eccentrically relative to each other. “Eccentric” here means that the input apertures and the output apertures are arranged such that they are not coaxial. In other words, the input apertures and the output apertures can be displaced relative to each other. Accordingly, during a turning process of the ampoules, a different arrangement structure can be provided at the output aperture than at the input apertures. In other words, the first arrangement structure can differ from the second arrangement structure (e.g., not be congruent). This offers the advantage that ampoules provided in an asymmetrical arrangement structure can also be transferred back into an asymmetrical arrangement structure after being turned. This means that even in an arrangement structure that provides the best utilisation of available space, the ampoules can be transferred back into such an arrangement structure. Thus, individual turning of the ampoules can be avoided, and a large number of ampoules can be turned simultaneously. This avoids separating the ampoules to provide a certain product distance and can achieve a high processing speed (e.g., 1000 ampoules per minute). The transition section can be movable so that the alignment of the input apertures and output apertures can be changed. This allows the device to be adapted to different initial situations (e.g., different arrangement structures in a nest). The transition section can be variable relative to the input apertures and/or the output apertures. For example, the transition section can be deformable and/or shiftable. Moreover, it is conceivable that the input section and/or the output section are also deformable and/or shiftable. This allows the device to be even better adapted to different initial situations.

Preferably, the first arrangement structure and the second arrangement structure differ, particularly in their spatial arrangement. In other words, the spatial coordinates (i.e., the spatial coordinates) of an input aperture and an output aperture assigned to this input aperture via the transition section can differ. More precisely, at least two spatial coordinates can be different. This allows any second arrangement structure (i.e., a structure in which the turned ampoules are output) to be provided for a given first arrangement structure (i.e., a structure in which the ampoules are provided).

Preferably, the input apertures and the output apertures are designed identically in terms of their geometric design. In other words, an input aperture and an output aperture assigned to this input aperture can have the same geometric cross-section. For example, both the input aperture and the output aperture can have a circular cross-section. Alternatively, both the input aperture and the output aperture can have a rectangular cross-section. This ensures that both geometric designs can serve as both input apertures and output apertures. Thus, by reorienting the device, both the geometry arranged above can serve as the input aperture, and the geometry arranged below (each viewed in the direction of gravity) can serve as the output aperture. This allows seamless operation of the device without the need to return the device to a specific starting position each time.

Preferably, the input apertures and the output apertures are arranged offset from each other in a top view of the device. This ensures that the output apertures are not congruent with the input apertures in a top view of the device. The top view of the device can be defined along the main transport direction of the ampoules from the input apertures to the output apertures. The main transport direction can extend along the direction of gravity. In some embodiments, the main transport direction is inclined relative to the direction of gravity. This allows an offset arrangement of the ampoules at the output apertures relative to the original arrangement at the input apertures.

Preferably, the input section, the output section, and the transition section are integrally formed. In other words, the device can be designed as a one-piece (i.e., integral) component. This simplifies the manufacture of the device and prevents errors when assembling a multi-piece system.

Preferably, each guiding means guides an ampoule along a guiding path, where the guiding means are designed so that the guiding path is deflected. Thus, the guiding means can transfer the ampoules from the input section to any second arrangement structure. Moreover, the spatial coordinates can be changed from an initial position where the ampoules enter the input section to a new position where the ampoules exit the output section from the device. Preferably, all three spatial coordinates can be changed.

Preferably, the input apertures, the output apertures, and/or the guiding means have a substantially round cross-section. In other words, the cross-section can be the area that defines the passage path for an ampoule from the input aperture to its assigned output aperture. The advantage of having identical cross-sections is that manufacturing can be simplified (e.g., in terms of mould design for injection-moulded parts). Alternatively, it is preferable that at least the input apertures and the output apertures have a substantially similar cross-section. The guiding means can also be a structural element that contacts the ampoules pointwise or sectionwise to direct them in the right direction. It is conceivable that the guiding means can also be designed as a kind of lattice frame. By providing the same cross-sections in the input apertures and the output apertures, it can advantageously be realised that, regardless of the orientation of the device, the input apertures can be swapped with the output apertures. Essentially, in the present case, this means that no strictly round shape is required but also includes shapes that deviate, for example, 5% from the ideally round shape. This can account for manufacturing tolerances. Preferably, the input apertures, the output apertures, and/or the guiding means have a substantially U-shaped cross-section. This offers the advantage that the device can be manufactured layer by layer. Each layer can have at least one input aperture, at least one output aperture, and at least one guiding means. The guiding means can be open on one side of the layer. Thus, each guiding means (and possibly each input section and/or output section) of the layer can be formed, for example, with a ball-end mill. The individual layers can then be assembled. This way, the guiding means can be closed by an adjacent layer. In other words, each layer can be realised as a milled disk. Here, the cross-section can correspond to a “U” for manufacturing reasons (ball-end mill from the side).

Preferably, the device is designed so that the ampoules can be gravity-driven from the input section to the output section. In other words, the device does not need to include an actuator or a drive device (such as a suction device or the like) to ensure that the ampoules are transferred from the input section to the output section. For example, a gravity-driven movement of the ampoule can be realised. This can be achieved, for example, by reorienting and/or shifting the device. For example, an ampoule can be provided at at least one input aperture, after which the ampoule is transferred gravity-driven by rotating the device about approximately 180° and transferred through the transition section to the output section. Because no separate actuator or the like is required to cause the movement of the ampoule, the system can be designed simpler overall.

Preferably, each guiding means includes at least one braking section designed to reduce the movement speed of an ampoule when guided from the input section to the output section. This can ensure that even delicate ampoules handled by the device are not damaged. The braking section can define a maximum allowable movement speed of the ampoule. The braking section can be an elastic protrusion element that protrudes into the movement path defined by the guiding means. As the ampoule passes the braking section, the ampoule can contact the braking section, and the braking section can decelerate the ampoule (i.e., reduce the speed). Moreover, it is conceivable that the braking section is a section with increased friction between the ampoule and the guiding means, thus reducing the movement speed of the ampoule. For example, the guiding means can have a section with increased friction, such as by providing a soft material in sections that, when in contact with the ampoule, reduces the movement speed of the ampoule. This is also advantageous in systems where the ampoules are gravity-driven from the input section to the output section. Here, the maximum movement speed of the ampoule can be limited. This can prevent damage to the ampoules.

Preferably, the device is designed as a moulded part. A moulded part can be a part designed for a specific insert purpose in a specially made production tool. Providing the device as a moulded part also offers the advantage that a user can easily replace the moulded part themselves. Thus, different moulded parts can be provided for different dimensions of ampoules. Moreover, different moulded parts can be provided for different arrangement structures (e.g., first arrangement structure and/or second arrangement structure). This can further simplify the insert of the device.

Preferably, the input apertures and the output apertures directly adjoin the guiding means. In other words, there is no other element between the input aperture and the output aperture except the guiding means, which are designed to guide the ampoule. This can achieve a compact dimension of the device. Moreover, this can minimise the path that an ampoule must travel from the input section to the output section (i.e., from the input aperture to the output aperture), reducing the risk of damage to the ampoule.

Preferably, the first arrangement structure and the second arrangement structure are defined by the arrangement of the input apertures and the output apertures in a two-dimensional plane. In other words, an arrangement structure can be characterised by how the apertures of the input section and the output section are arranged in a two-dimensional plane. Consequently, an arrangement structure can also be defined by the arrangement in which the ampoules are provided to the device. For example, the ampoules can be arranged in a container (e.g., in a nest that is housed in a tub) in a certain way. The arrangement of the ampoules can correspond to the arrangement structure. The first arrangement structure can describe the arrangement in which the ampoules are provided to the device or are present before handling by the device. The second arrangement structure can describe how the ampoules, after being turned, are output by the device. Thus, the arrangement structure of the input apertures, i.e., how the input apertures are arranged, is defined by how the ampoules are provided to the device. This can be defined, for example, by how the ampoules are delivered by a filler (i.e., the person filling the ampoules with a drug). In contrast, the second arrangement structure can be defined by the device (i.e., by the arrangement structure of the output apertures). In other words, any second arrangement structure can be provided by the device. In one embodiment of the present invention, it is advantageous if the first arrangement structure defined by the filler is specified by a specific transport container (e.g., a nest in a tub). According to the above embodiments, the device is capable of designing the second arrangement structure (i.e., the arrangement structure output by the device) so that the turned ampoules can be reinserted into the transport container from which they were taken. This offers the advantage that no separate or differently designed transport container is required, but the transport container originally provided by the filler can also be used for the turned ampoules. This also offers the advantage that an identification method and tracking method that begins with the filler can also be continued in the further processing sequence (preferably with the determination procedure described below).

Preferably, the device includes polyoxymethylene, polyamide, polytetrafluoroethylene, and/or polyethylene terephthalate. Polyoxymethylene (POM) is characterised by high strength, hardness, and rigidity over a wide temperature range. This makes it particularly durable and has a long life expectancy. Polyamide also has high strength, rigidity, and toughness, as well as very good chemical resistance and processability. Additional properties can be defined through the amide groups of polyamides. This depends on the specific use of the device, as chemical cleanings often need to be carried out due to hygiene requirements. For example, in some areas, cleaning is done with hydrogen peroxide, which attacks many other materials. Accordingly, it is advantageous to use a high-quality plastic in the present device to ensure durability. In other insert areas, this would be unnecessary and would represent unnecessary costs. Moreover, it is conceivable to use polytetrafluoroethylene (PTFE). PTFE is also known under the trade name Teflon. It is particularly advantageous that a very low coefficient of friction can be achieved, allowing the ampoules to be handled smoothly through the device. Moreover, PTFE is very inert, so even aggressive acids do not attack PTFE. Additionally, it is conceivable to use polyethylene terephthalate (PET). PET also has high resistance to chemicals and is accordingly widely used in medical technology and the food industry. Additionally, PET has high mechanical resistance, which also ensures increased durability of the device.

Preferably, the ampoules have a content of max. 20 ml. This allows the ampoules to be used in ampoule syringes.

Preferably, the medical ampoules are arranged in a nest. In other words, the ampoules provided for turning by the device are arranged in a holder or a holding structure (i.e., a nest). In general, the ampoules can stand on their bottom due to gravity. In other words, the ampoules can stand on the bottom in a tub and be held by a grid-like structure (the nest). In contrast, syringes are transported hanging. The nest can hold the ampoules. Thus, the nest can be designed to hold the ampoules in a specific arrangement, particularly spaced apart from each other. The weight can be held by the nest and/or by other elements such as a tub (more details below). The nest can be responsible for the first and/or second arrangement structure.

Preferably, the medical ampoules are held in the nest at the shoulder area of each ampoule. The shoulder area of the ampoule can be a particularly robust area, so the ampoule can be held here best without risking damage. Moreover, the nest can be designed to lift the ampoules out of the tub. For this purpose, the nest can be designed to hold the ampoules at an area adjacent to a relatively thicker area (e.g., a cap area or a syringe contact element). This allows the ampoules to be lifted out of the tub by the nest. Preferably, the nest is designed so that the ampoules can only be held in one direction, allowing the ampoules to be tipped out of the nest.

Preferably, the nest is arranged in a tub. The tub can be a shell-like structure in which the nest, together with the ampoules, is arranged. The nest can be designed to fit precisely into the tub. This can prevent relative movements of the nest relative to the tub.

Preferably, the tub has an identification element. The identification element can indicate, for example, which ampoule is placed in which position in the tub and/or in the nest provided in it. Moreover, additional information can be retrieved via the identification element, such as the type of contents and/or process-oriented prerequisites or requirements.

According to another aspect of the present invention, a turning device for turning medical ampoules is provided, comprising a device according to one of the previous embodiments. The turning device can include a holding device for holding the device. The holding device can be designed to move the device along a first direction. The holding device can be designed to rotate the device around a first axis. The turning device can represent an automated insert of the device according to one of the above embodiments. In other words, the above-described device can be used manually or in the course of other handling or processing of the ampoules. The now described turning device can be an individual handling device designed to turn the ampoules. Preferably, the turning device is at least partially automated so that at least some of the handling steps can be carried out fully automatically. This can reduce manual work and increase efficiency. The holding device can be a structural device that can hold the device movably. Preferably, the holding device is a two-armed device that rotatably supports the device at an outer end of each arm. The two arms can be connected to a base arm. The base arm can be movably arranged on a stand or mast. This can realise that the holding device can move the device along a first direction. The first direction can extend along the direction of gravity. Due to the rotatable support of the device on the two arms of the holding device, the holding device can rotate the device around a first axis. Preferably, the device is held on the holding device such that the first axis passes through a center of gravity of the device. This can achieve a particularly homogeneous (e.g., jerk-free) rotational movement around the first axis.

Preferably, the first direction and the first axis are orthogonal to each other. Thus, by moving in the first direction, the ampoules can be picked up and then or at least partially simultaneously be transferred by rotating the device around the first axis. In other words, by moving in the first direction, a nest can be lifted out of a tub and, once the nest is lifted out of the tub, a gravity-driven movement of the ampoules can be initiated to move from the input aperture to the associated output aperture (e.g., in the main movement direction).

Preferably, the first direction extends along the direction of gravity. This offers the advantage that the ampoules remain in their original place as long as the device moves only in the first direction due to gravity. Only by rotating around the first axis is a movement of the ampoules through the device effected.

Preferably, the turning device includes an actuator, where the actuator can be designed to execute the movement in the first direction and/or the rotation around the first axis. In other words, only a single actuator can be provided, responsible for the movement in the first direction and the rotation around the first axis. This can be realised, for example, by mechanical control of the holding device. By providing only a single actuator, the control electronics and control effort can be reduced. Moreover, by a single actuator (i.e., by mechanical control of both movements, i.e., the translational movement in the first direction and the rotational movement around the first axis), a synchronised movement sequence can be realised so that the movement is executed in the desired order and at a desired time. Thus, the system can be designed simpler and at the same time more reliable. Preferably, the turning device has a control unit that can be designed to obtain an initial position of the medical ampoules and to determine a new position of the medical ampoules after leaving the output apertures. This is particularly advantageous when the ampoules are provided to the turning device in a specific arrangement. For example, it is conceivable that a tub with a nest full of ampoules is provided by a filler, with identification means or other information transfer indicating exactly which ampoule is located at which position. This is particularly important in tracking systems. If the ampoules are now turned by the turning device, it must still be clear which ampoule is located at which position in the turned state. This depends on how the transition section guides the ampoules from the input apertures to the output apertures. The control unit can determine which original position of the ampoule corresponds to which position of the ampoule after turning based on the type of device used in the turning device. In other words, the control unit can mathematically determine where each ampoule is located after the turning process by the turning device. This can then be output by the control unit and, for example, transmitted to a database. Thus, it can be clearly determined where each ampoule is located in the nest in the tub after the ampoules have been turned by the turning device.

Preferably, the turning device includes a holding device designed to hold a first nest with a plurality of ampoule holding places such that each ampoule holding place is opposite one of the input apertures. As described above, the first arrangement structure is determined by how the ampoules are provided to the device or the turning device. The device is accordingly adjusted. For further automation, the turning device can now include a holding device that can grip a nest so that the ampoules present in the nest are exactly opposite an input aperture of the device. This offers the advantage that when the device is rotated around the first axis, the ampoules slide out of the nest and into the device.

Preferably, the holding device is designed to hold a second nest with a plurality of ampoule holding places such that each ampoule holding place is opposite one of the output apertures. In other words, the turning device can hold two nests via the holding device. This is particularly advantageous if the ampoules are to be returned to a nest or a tub in a turned state. According to one embodiment of the present invention, the ampoules are returned to an identical nest to the one from which the ampoules were taken and to the same tub from which the ampoules were taken. In other words, the turning device only changes the orientation of the ampoules while keeping the transport means of the ampoules the same. Thus, the turning device can be easily integrated into an existing process without requiring structural changes to the process. According to the present embodiment, the turning device includes a first nest on the side of the input apertures and a second nest on the side of the output apertures. The ampoule holding places in each nest can be opposite the respective input apertures and output apertures. This ensures that the ampoules can be transferred from the input aperture through the transition section to an associated output aperture (e.g., gravity-driven). The holding device can be designed to hold the first nest and the second nest on the device.

Preferably, the holding device is a suction device. The suction device can include at least one suction cup that can suck up a nest and thus lift it out of a tub. The suction device can also be referred to as a suction gripping device. The holding device can be designed to apply a suction force to a shoulder of a nest to hold it. Alternatively, a mechanical gripping device can be provided that can grip and hold a nest.

Preferably, the turning device includes at least one positioning aid that can be designed to ensure a predetermined position of a nest when the nest comes into contact with the turning device. The positioning aid can help align an ampoule holding place in a nest with a respective aperture in the device. This ensures an optimal alignment of a nest relative to the device. This ensures smooth operation of the turning device.

Preferably, the positioning aid includes a projection that protrudes from the turning device and can be designed to interact with a nest. Thus, the positioning aid can include at least one projection protruding from the device. The projection can, for example, have a tapered shape towards its outer end and interact with an aperture in a nest. When a nest approaches the device, the projection can be guided into the recess of the nest and, through the shape of the projection, guide the nest and/or the input device to achieve an optimal position between the nest and the device. This can further increase process safety.

Preferably, the turning device includes at least one distance element designed to ensure a predetermined distance of a nest from the turning device when the nest comes into contact with the turning device. The distance element can serve to limit the distance between the device and the nest to a minimum. This can prevent damage due to direct contact between the ampoules contained in the nest and the device. For example, this allows ampoules of different heights to be processed by the turning device without any problems. Moreover, a less precisely controllable gripping device can be used, which can grip and hold a nest and guide it to the device until the distance element comes into contact with the nest element. The distance element can, for example, be a projection that can interact with a shoulder of the nest. This can increase process safety and prevent damage to the ampoules.

Moreover, it is conceivable that the control unit can control the rotation around the first axis such that the rotation is not continuous but adaptive or variable. This offers the advantage that free-falling of the ampoules from the first nest towards the second nest (i.e., from the input aperture to the assigned output aperture) can be avoided. By rotating around the first axis, the static friction between the ampoule and the nest or device is overcome and transitions to sliding friction. Since the sliding friction is lower than the static friction, a sudden acceleration of the ampoule occurs due to gravity. For this purpose, the control unit can be designed to rotate the device around the first axis only until the static friction is overcome. Then, the rotation can be stopped to avoid further acceleration of the ampoule. The stop can occur after a rotation angle of at least 90°. Preferably, the stop occurs after a rotation angle in the range of 100° to 135°. This has proven advantageous in handling glass ampoules as it overcomes the static friction in this range. According to a particularly preferred embodiment, the control unit can even perform a short reverse rotation after overcoming the static friction to avoid excessive acceleration of the ampoule. For example, a reverse rotation of the device by about 5° can occur. This allows particularly sensitive ampoules to be handled without any problems by the turning device. Once the ampoules have passed through the device and been captured in the second nest, the control unit can complete the remaining rotation to accomplish the 180° rotation.

Preferably, the turning device includes a sensor that can determine the position of the ampoules. The sensor can be, for example, a center of gravity sensor that determines the center of gravity of the device together with the first nest and the second nest. Since one nest is filled with ampoules and the other nest is empty, the center of gravity will not lie on the first axis. Depending on where the center of gravity is located, the control unit can determine the current position of the ampoules. This allows the control unit to detect the start of the movement of the ampoules (i.e., the overcoming of static friction). The control unit can then adjust the rotational movement around the first axis. Thus, for example, the rotational movement can also be continued more slowly than at the beginning to achieve the desired movement speed of the ampoules. This can automatically be based on pre-stored information. This eliminates the need for individual adjustment, for example, when handling ampoules with different fill volumes. This further increases operational safety and reduces the damage rate of the ampoules.

According to another aspect of the present invention, a method for turning medical ampoules using a device is provided. The method includes providing a plurality of medical ampoules in a first arrangement structure, picking up the ampoules in each input aperture of the device, guiding the ampoules through a guiding means of the device from the input apertures to the output apertures of the device, and outputting the ampoules from the output apertures in a second arrangement structure, where the first arrangement structure differs from the second arrangement structure.

Preferably, the ampoules are provided in a first nest, and the method includes holding the first nest on the device. The holding can be realised, for example, by a suction gripping device. Preferably, the ampoules are output into a second nest, where the second nest is held on the device. The second nest can have the same geometric dimensions as the first nest. The first nest can be held on the device so that the ampoules can be introduced into the input apertures. The second nest can be held on the device so that the ampoules output by the device can be received by the output apertures of the second nest. Preferably, the method includes moving the device so that the ampoules are gravity-driven from the input apertures to the output apertures through the guiding means. Preferably, the moving includes rotating the device around a first axis. Preferably, the first nest is provided in a tub, and the first nest is lifted out of the tub along a first direction. Preferably, the second nest with the ampoules is inserted back into the tub from which the first nest was taken. Thus, the ampoules are returned to the same tub from which they were taken. In other words, identification means provided on the tub remain valid for the ampoules even after the turning process. Preferably, the method includes recording an identification of the tub in which the ampoules are provided.

Preferably, the method further includes determining a new position of the ampoules in the second nest. The method can then output the information about the new position of the ampoules in the tub and base further processing on this. After the ampoules have been turned, they can be subjected to an inspection. Preferably, 120 ampoules can be provided in each tub. In other words, 120 ampoules can be turned at once. Preferably, the average distance between the ampoules in a nest is approximately 116 mm.

According to another aspect of the present invention, the use of a device according to one of the above embodiments for turning medical ampoules is provided. In particular, the use of the device in one of the above turning devices is provided. This can provide an advantageous process flow with increased efficiency.

Individual features of the above embodiments can be combined with other embodiments or other features to form new embodiments. Configurations and advantages mentioned in connection with the features or embodiments also apply analogously to the new embodiments. Advantages and configurations mentioned in connection with the method also apply analogously to the device and vice versa.

### BRIEF DESCRIPTION OF THE DRAWINGS

In the following, preferred embodiments are described in detail with reference to the accompanying figures.

FIG. 1 is a schematic cross-section of a device according to one embodiment of the present invention;

FIG. 2 is a schematic and perspective view of a tub, nest, and a plurality of ampoules as used in one embodiment of the present invention;

FIG. 3 is a schematic view of a nest filled with ampoules;

FIG. 4 is a schematic view of a nest filled with ampoules housed in a tub as provided in a turning device according to one embodiment of the present invention;

FIG. 5 is a schematic and perspective view of a turning device according to one embodiment of the present invention;

FIG. 6 is a schematic side view of a turning device according to one embodiment of the present invention;

FIG. 7 is a schematic and perspective view of a device according to one embodiment of the present invention as used in a turning device according to one embodiment of the present invention;

FIG. 8 is a schematic and perspective view of a turning device according to one embodiment of the present invention; and

FIG. 9 are multiple schematic and perspective views of a turning device in operation according to one embodiment of the present invention.

### DETAILED DESCRIPTION OF THE PREFERRED EMBODIMENTS

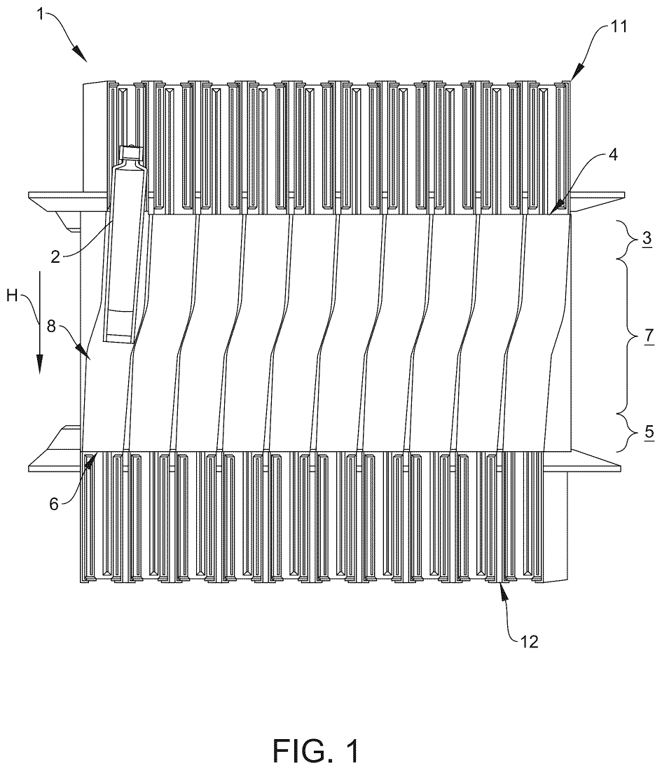

FIG. 1 is a schematic cross-sectional view of a device 1 according to one embodiment of the present invention. The device 1 includes an input section 3, a transition section 7, and an output section 5. The input section 3 has a plurality of input apertures 4 (only one input aperture is labelled with reference numeral 4 in FIG. 1). The device 1 is designed to transport medical ampoules 2. In other words, the device can move the ampoules 2 and output them at a different spatial position. For this purpose, the ampoules 2 can be received at the input section 3 through the input apertures 4. Each input aperture 4 can only accommodate one ampoule 2. Subsequently (i.e., downstream), the ampoules 2 can enter a transition section 7. The transition section 7 has a plurality of guiding means 8 designed to guide the ampoules 2. The guiding of the ampoules 2 in the present embodiment involves outputting the ampoules 2 at a different location. The output of the ampoules 2 occurs through the output section 5, which has a plurality of output apertures 6. The ampoules 2 can be provided, for example, in a first nest 11 (shown at the top in FIG. 1). The ampoules 2 can then exit the first nest 11, enter the device 1 through the input apertures 4, be guided through the transition section 7 and the guiding means 8 provided therein, and finally exit the device 1 through the output apertures 6. Adjacent to the output apertures 6, a second nest 12 can be arranged to receive the ampoules 2 after they leave the device 1. It is not necessarily required to provide a second nest 12, as other devices for capturing the ampoules can also be provided. For example, it is conceivable that the ampoules 2 are processed further directly in a process. However, in a preferred embodiment, the ampoules 2 are introduced into a second nest 12 after they have exited the output apertures 6, where the second nest 12 is identical to the first nest 11. During the passage of the ampoules 2 through the device 1, the ampoules 2 are transported along a main conveying direction H (see arrow in FIG. 1). In other words, the ampoules 2 are moved by the device 1 in all three spatial directions (X, Y, and Z directions).

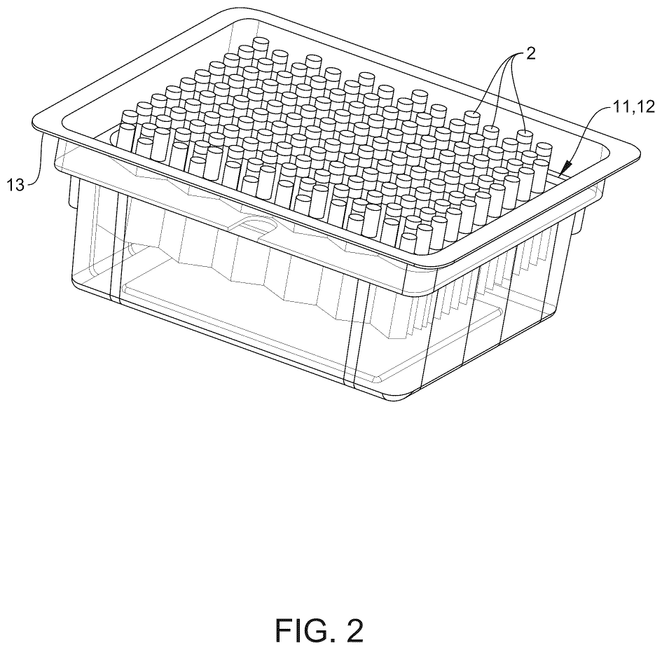

FIG. 2 is a schematic and perspective view of a nest 11, 12 with a plurality of ampoules 2 contained therein. The nest is arranged in a tub 13. Tubs 13 with nests are typically used to transport ampoules 2 filled with drugs from a filler to a further processing unit. The nest 11, 12 and the tub 13 are often steam sterilised to enable safe handling even in sterile areas. The nest 11, 12 serves to prevent direct contact between the ampoules 2. This reduces the risk of damage due to glass-to-glass contact. To maximise the number of ampoules in a nest 11, 12, the ampoules are arranged in a first arrangement structure in the nest 11, 12. When these ampoules 2 come from a filler, they are oriented with the bottom side up because the filler fills the ampoules, which are intended for use in ampoule syringes, from the bottom. If the ampoules 2 are to undergo visual inspection, it is necessary to turn the ampoules. This is because the upper part of the ampoules (i.e., the area where the syringe is attached to extract the drug from the ampoule) obscures part of the ampoule or its contents. Accordingly, the ampoules must be turned or flipped. In the situation shown in FIG. 2, the ampoules are already correctly oriented for inspection.

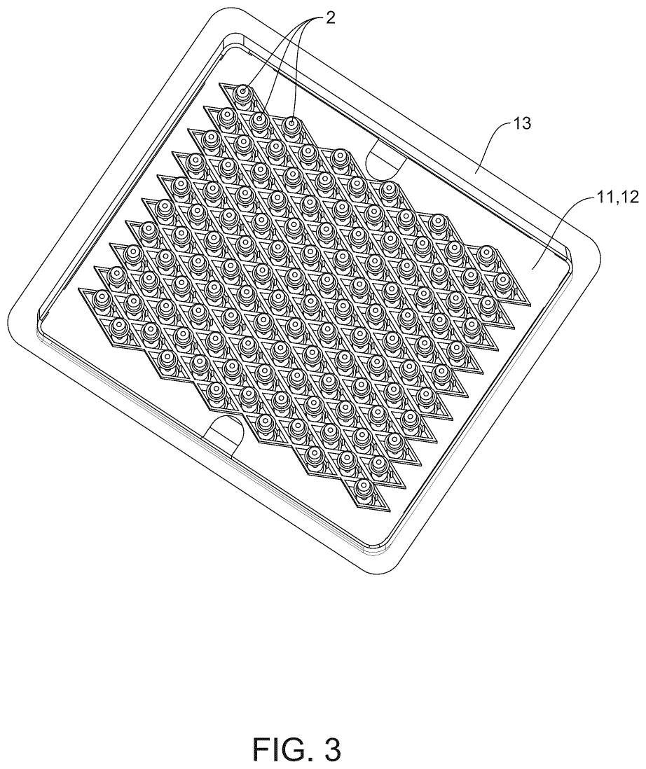

FIG. 3 is a schematic and perspective view of a nest 11, 12 housed in a tub 13 from an oblique top view. It can be seen that the ampoules 2 are each held in a diamond-shaped section (ampoule holding place). If this arrangement structure is, for example, turned upside down (i.e., rotated) 180° and placed on an empty nest with the same configuration, the ampoules 2 would not fall into the diamond-shaped holding places of the new nest because the holding places are not aligned. To address this problem, the device 1 of the present invention is used to transfer the ampoules 2 into a different arrangement structure while turning the ampoules 2.

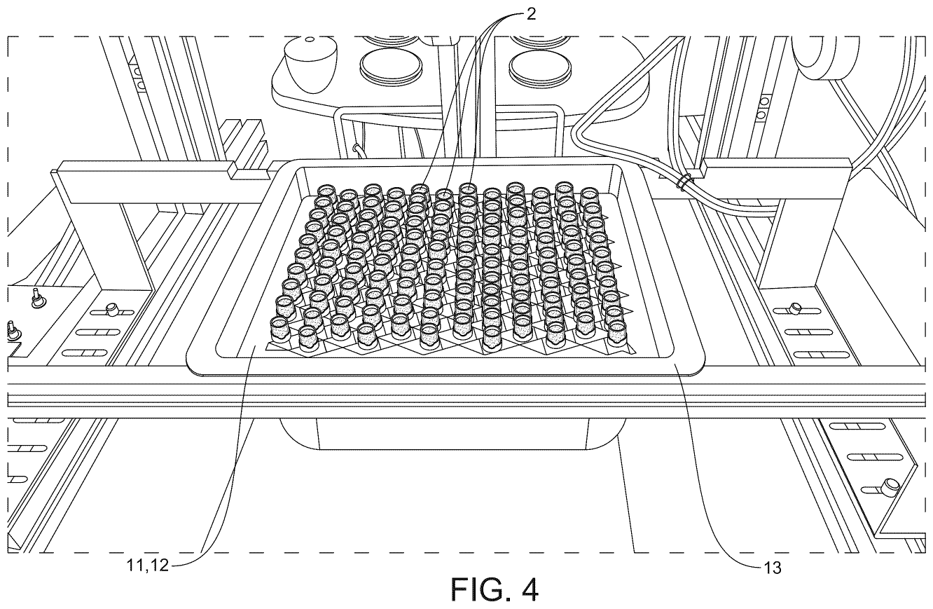

FIG. 4 is a schematic and perspective view of a tub 13 with a nest 11, 12 containing a plurality of ampoules 2. In this situation, the ampoules 2 are oriented in a manner that requires turning for subsequent inspection. In other words, the ampoules 2 are oriented with the bottom up. Thus, the situation shown in FIG. 4 represents an initial situation before turning the ampoules 2.

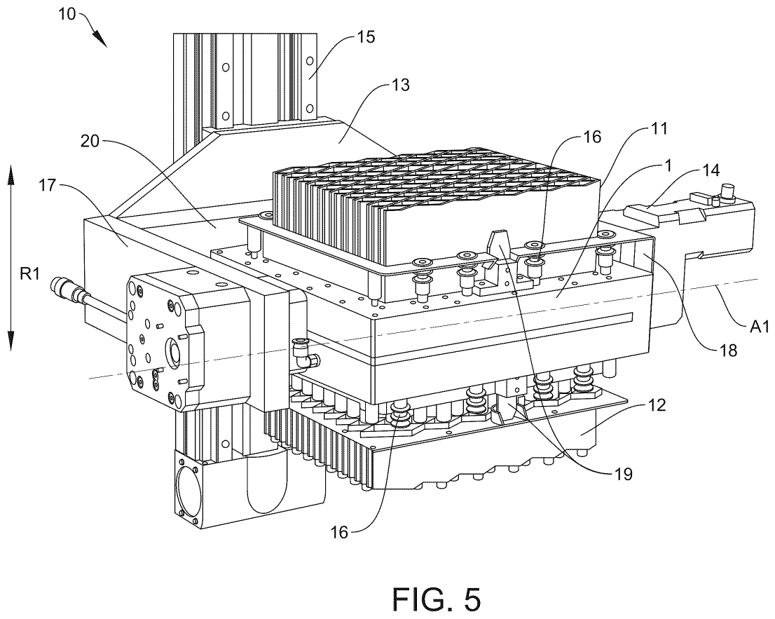

FIG. 5 is a schematic and perspective view of a turning device 10 according to one embodiment of the present invention. The turning device 10 is used to transfer the medical ampoules 2 from the initial situation shown in FIG. 4 to the final situation shown in FIG. 3. For this purpose, the device 1 shown in FIG. 1 is arranged in the turning device 10. The turning device 10 also includes a holding device 13 that can hold the device 1. The turning device 10 can rotate the device 1 around a first axis A1. For this purpose, the turning device 10 has two actuators 14. Moreover, the holding device 13 can be moved along a first direction R1 (i.e., translationally). In the present embodiment, the first direction R1 extends along the direction of gravity (i.e., from bottom to top). The turning device 10 holds a first nest 11 and a second nest 12 on two opposite sides of the device 1. The first nest 11 contains the ampoules 2. The second nest 12 is empty and identical to the first nest 11. Since the first nest 11 is opposite the second nest 12, the ampoule holding places in the respective nests 11, 12 are not aligned. Only the device 1 connects the ampoule holding places in the first nest 11 with the ampoule holding places in the second nest 12 via the input section 3, the transition section 7, and the output section 5. By rotating the turning device 10 around the first axis A1, the main movement direction H of the ampoules through the device can be chosen arbitrarily. In the present embodiment, the ampoules 2 arranged incorrectly in the first nest 11 are transferred into the second nest 12 through the device 1 by rotating around the first axis A1. In the second nest 12, the ampoules 2 then lie with the upper side facing upwards. Thus, all ampoules 2 provided in the first nest 11 can be turned at once. This eliminates the need for individual handling of single ampoules or rows of ampoules and allows the entire matrix of ampoules to be transferred from the first nest 11 to the second nest 12 directly to change the orientation of the ampoules. The turning device 10 includes the holding device 13 that can hold and move the device 11. For this purpose, the holding device 13 can have a first arm 17 and a second arm 18. Overall, the holding device 13 can have a U-shaped cross-section, with the first arm 17 and the second arm 18 extending from a connecting arm 20. The connecting arm 20 can be movably fixed to a stand or mast 15. More precisely, the connecting arm 20 can be guided in a rail provided on the stand 15. This can define the first movement direction R1. In a preferred embodiment, the turning device 10 can be moved automatically along the first direction R1. This can be realised, for example, by a threaded rod or by a gear that can be engaged with a rack. This allows the turning device to lift the first nest 11 out of a tub 13. The turning device 10 only needs to lift the first nest 11 out of the tub 13 far enough to rotate it around the first axis A1. The second nest 13 can initially be provided on one side of the device 1 facing the output apertures 6.

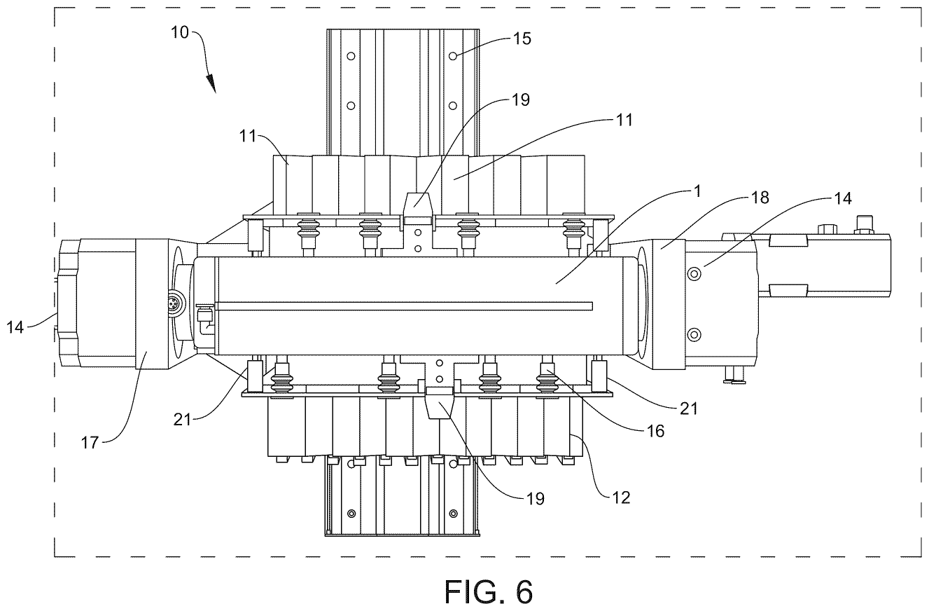

FIG. 6 is a schematic side view of the turning device 10 according to one embodiment of the present invention. The present embodiment corresponds to the embodiment shown in FIG. 5. In FIGS. 6 and 5, it can be seen that a gripping device 16 is provided on the turning device 10. In the present embodiment, the gripping device 16 is designed as a suction gripper. In particular, in the present embodiment a plurality of suction grippers 16 are arranged, which are designed to lift and hold a nest 11, 12 out of a tray 13. This can ensure that the nest 11, 12 does not fall off the insert 1 during the turning process. Moreover, the turning device of the present embodiment comprises a positioning aid 19. In the present embodiment, the positioning aid 19 is designed as a projection that protrudes from the insert 1. The positioning aid 19 has a shape that tapers towards the outer end. Thus, the positioning aid 19 can co-operate with an aperture in the nest 11, 12 and thus ensure the correct position of the nest relative to the insert 1. This ensures that both the input apertures 4 and the output apertures 6 are each opposite an ampoule holding position in the first nest 11 and the second nest 12. Moreover, the turning device has a plurality of spacer elements 20 which are designed to maintain a distance between the nest 11, 12 gripped by the turning device 10 and the insert 1. This prevents ampoules 2 that are stored in the nest 11, 12 from being damaged by direct contact with the insert or other objects. The spacer elements can be cylindrical rods, for example, which protrude from the turning device. The distance elements can contact the nest 11, 12 directly.

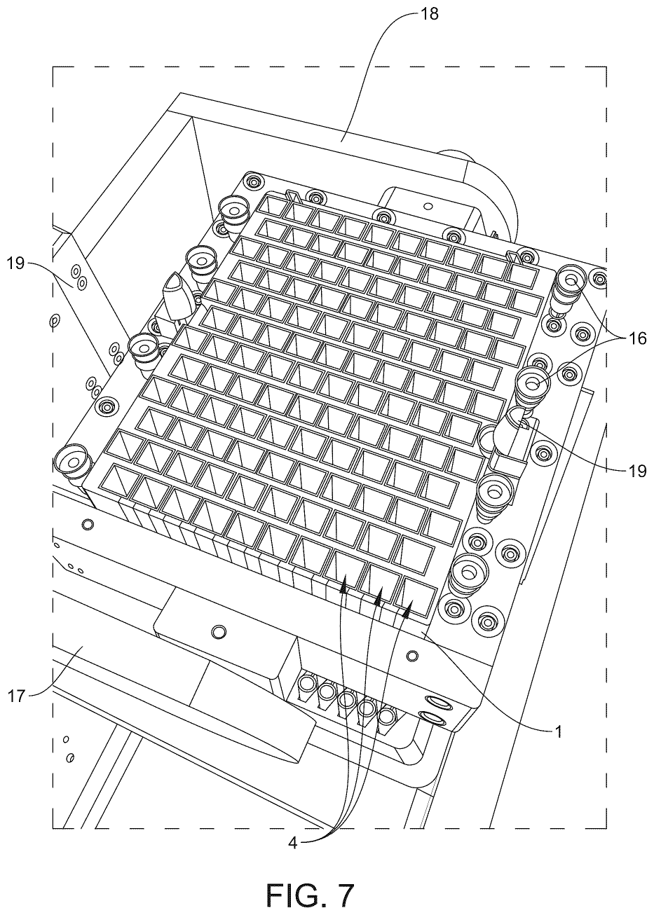

FIG. 7 is a perspective view of the turning device 10 without a nest 11, 12 provided on it. The top of the insert 1 with the input apertures 4 provided on it can be seen. The suction grippers 16 are also recognisable. In the present embodiment, eight suction grippers 16 are provided, four of which are arranged on each side. The positioning aid 19 is provided in the centre of each side of the insert 1. In the present embodiment, the input apertures 4 have a rectangular cross-section. The guide means 8 are also provided with a rectangular cross-section. The output apertures 6 are also provided with an angular cross-section. In a further embodiment not shown, the cross-sections of the input apertures 4, the guide means 8 and the output apertures 6 have a round cross-section.

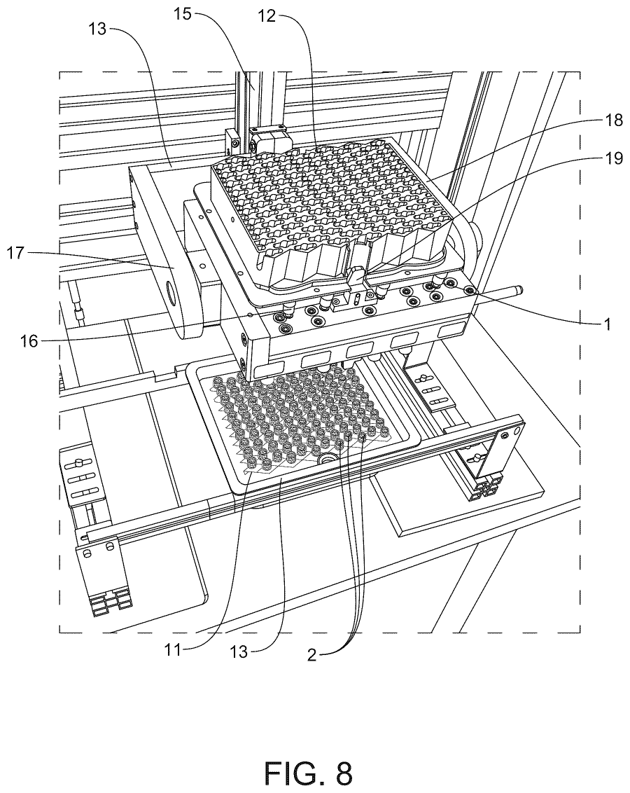

FIG. 8 is a perspective view of the turning device immediately before a first nest 11 is picked up. It can be seen that a second nest 12, which is empty, is arranged on one side of the insert 1. A tub 13 filled with ampoules 2 with a nest 11 is provided below the turning device 10. The turning device 10 is then moved along the first direction R1 towards the first nest 11. On contact with the first nest 11, the positioning aid will fine-tune the position of the first nest 11 until the mature suction grippers 16 come into contact with the first nest. The first nest 11 is then sucked in and lifted out of the tub 13 in the first direction R1. Above the tub 13, the insert 1 is rotated about the first axis A1 so that the ampoules 2 are transferred from the first nest 11 through the insert 1 into the second nest 12. The speed of rotation around the first axis is controlled by a control unit. In a preferred embodiment, the control unit (not shown in the figures) can control the rotation so that the insert 1 is stopped or rotated in the opposite direction after overcoming the static friction of the ampoules 2 in the first nest 11. This prevents excessive acceleration of the ampoules 2 in the main conveying direction H. Once the ampoules 2 have arrived in the second nest 12, the rotation can be completed so that the insert has been rotated once through 180°. The second nest 12 can then be reinserted into the original tub 13 by moving the turning device 10 in the first direction. In this way, an identification which is arranged on the tub 13 can be retained, as the same ampoules 2 are again arranged in the same tub 13 (only with a different nest). The control unit can also be designed so that the new position of the ampoules 2 is compared with the data arranged on the tub 13, so that it is stored which ampoule 2 is arranged in which position in the second nest 12. In other words, the location of an ampoule 2 as it was in the first nest 11 can be converted by the control unit so that it is known where the same ampoule is located in the second nest 12. This makes it possible to trace the ampoules through the entire process of handling the ampoules 2.

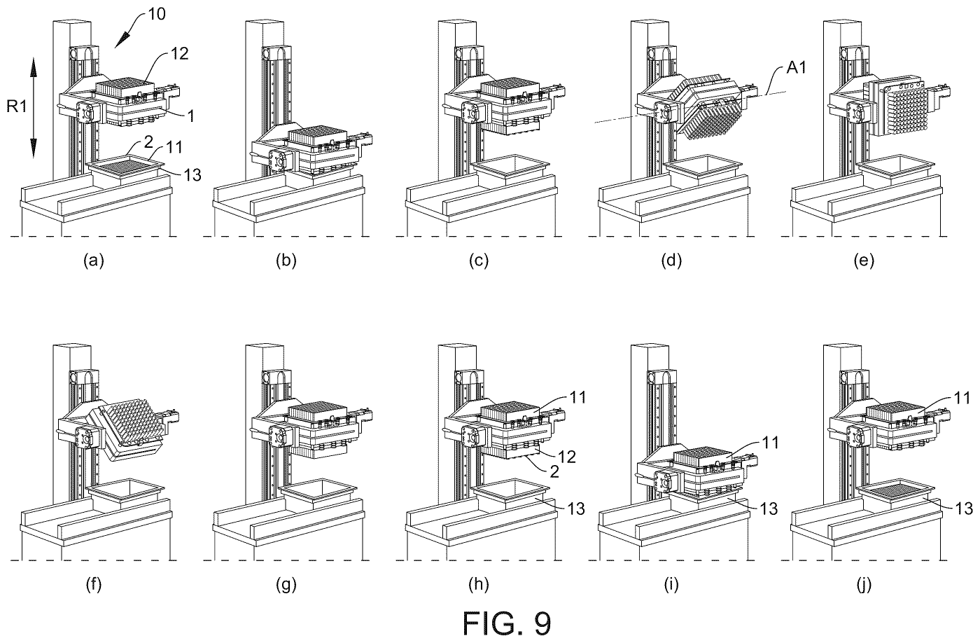

FIG. 9 shows ten individual images (a) to j)), which illustrate the work step of turning medical ampoules. FIG. 9(a) shows the provision of medical ampoules 2 in a nest 11, which is arranged in a tray 13. In FIG. 9(b), the turning device 10 is lowered onto the first nest 11 and gripped by the suction grippers. The turning device already has a second nest 12 on the opposite side of the insert 1. In FIG. 9(c), the nest 11 is lifted out of the tub 13 in the first direction of movement R1. In FIG. 9(d), a rotation around the first axis of rotation A1 begins in order to transfer the ampoules 2 from the first nest 11 to the second nest 12. In FIG. 9(e), the rotation by 90° has taken place, such that no ampoule 2 has yet been transferred from the first nest 11 to the second nest 12. In FIG. 9(f), the rotation continues around the first axis A1. In FIG. 9(g), the rotation about the first axis A1 is completed, such that the insert 1 together with the first nest 11 has been rotated by 180°. In FIG. 9(h), a cap is opened, allowing the ampoules 2 to pass through the insert 1. Driven by gravity, the ampoules pass from the first nest 11 through the insert 1 into the second nest 12. In FIG. 9(i), the turning device 10 moves downwards again along the first direction R1 in order to reinsert the second nest 12 with the now turned ampoules 2 into the tub 13. In FIG. 9(j), the turning device 10 is moved upwards again along the first direction R1 in order to release the tub 13 for further processing.

The turning device 10 shown in FIG. 9 differs from the previously shown turning device 10 in that the passage through the insert 1 can be opened and closed by a lock (not shown in figures). This means that it is possible to actively control when the ampoules 2 can be transferred through the insert 1. In the embodiments described above, transfer of the ampoules 2 began when the static friction between the ampoule and the nest was overcome. In the present embodiment, this is actively controlled by the lock.

In a further embodiment not shown, it is conceivable that a large number of turning devices 10 are arranged along a handling line in order to be able to turn several nests in parallel. This means that the output can be further increased.

### LIST OF REFERENCE SIGNS

1 Insert
2 Ampoule
3 Input section
4 Input aperture
5 Output section
6 Output aperture
7 Transition section
8 Guide means
10 Turning device
11 first nest
12 second nest
13 tub
14 Actuator
15 Bar
16 Suction gripper
17 first arm
18 second arm
19 Positioning aid
20 Connection arm
21 Distance element
H Main direction of movement
R1 first direction
H1 first axis

The invention claimed is:

1. An insert for a turning device for medical ampoules, comprising:
an input section which has a plurality of input apertures for receiving a respective ampoule, wherein the input apertures are provided in a first arrangement structure;
a dispensing section having a plurality of output apertures for dispensing one ampoule at a time, wherein the output apertures are provided in a second arrangement structure; and
a transition section which has a plurality of guides, the transition section being arranged and/or designed in such a way that ampoules can pass from the input apertures through the plurality of guides to the output apertures;
wherein the input apertures and the outlet apertures are arranged eccentrically relative to each other.

2. The insert according to claim 1, wherein the input apertures and the output apertures are arranged offset relative to one another in a plan view of the insert.

3. The insert according to claim 1, wherein the input section, the output section and the transition section are integrally formed.

4. The insert according to claim 1, wherein each guide comprises at least one braking portion configured to reduce a speed of movement of an ampoule when guiding from the input portion to the dispensing portion.

5. The insert according to claim 1, wherein the insert comprises polyoxymethylenes, polyamide, polytetrafluoroethylene and/or polyethylene terephthalate.

6. A turning device for turning medical ampoules, comprising:
an insert according to claim 1;
a holder for holding the insert;
wherein the holder is configured to move the insert along a first direction; and
wherein the holder is configured to rotate the insert about a first axis.

7. The turning device according to claim 6, wherein the first direction and the first axis are orthogonal to each other.

8. The turning device according to claim 6, further comprising:
an actuator configured to perform the movement in the first direction and the rotation about the first axis.

9. The turning device according to claim 6, further comprising:
a control unit configured to obtain an original position of the medical ampoules and to determine a new position of the medical ampoules after leaving the output apertures.

10. The turning device according to claim 6, wherein the holding device is configured to hold a first nest with a plurality of ampoule holding positions such that one ampoule holding position is opposite one of the input apertures in each case.

11. The turning device according to claim 10, wherein the holding device is configured to hold a second nest with a plurality of ampoule holding locations such that one ampoule holding location is opposite one of the output apertures.

12. The turning device of claim 6, wherein the holding device is configured to hold a nest with a plurality of ampoule holding locations such that one ampoule holding location is opposite one of the output apertures.

13. The turning device according to claim 6, further comprising:
at least one positioning aid configured to ensure a predetermined position of a nest upon contact of the nest with the turning device.

14. A method for turning medical ampoules via an insert, comprising:
providing a plurality of medical ampoules in a first arrangement structure;
picking up the ampoules in one of the input apertures of the insert;
guiding the ampoules through a guide of the insert from the input apertures to the output apertures of the insert; and
dispensing the ampoules from the output apertures in a second arrangement structure;
such that the first arrangement structure differs from the second arrangement structure.
